(19) United States
(12) Patent Application Publication
(10) Pub. No.: US 2025/0289441 A1
(43) Pub. Date: Sep. 18, 2025

(54) METHOD AND APPARATUS FOR CALIBRATING ORIENTATION ANGLE OF VEHICLE SENSOR

(71) Applicants: Hyundai Motor Company, Seoul (KR); Kia Corporation, Seoul (KR)

(72) Inventor: Eun Jo PARK, Pyeongtaek-si (KR)

(73) Assignees: Hyundai Motor Company, Seoul (KR); Kia Corporation, Seoul (KR)

(21) Appl. No.: 18/971,294

(22) Filed: Dec. 6, 2024

(30) Foreign Application Priority Data
Mar. 14, 2024 (KR) 10-2024-0035583

(51) Int. Cl. B60W 40/11; B60W 40/13

(52) U.S. Cl. CPC B60W 40/11; B60W 40/13; B60W 2420/403; B60W 2520/16; B60W 2530/10

(57) ABSTRACT

In a method and an apparatus for calibrating an angle of camera sensor, the APPARATUS includes one or more processors configured for storing a front-angle change amount information which includes a front-angle change amount of an image sensor mounted on a vehicle according to a total loading weight, a front-axle loading weight, and a rear-axle loading weight by a load of the vehicle; determining a full weight which is actual total loading weight of the front-axle, a first weight which is an actual loading weight of the front axle and a second weight which is an actual loading weight of the rear axle, predicting the front-angle change amount of the image sensor by referring to the front-angle change amount information based on the full weight, the first weight and the second weight and controlling the autonomous driving vehicle by use of the front-angle change amount of the image sensor.

### CROSS-REFERENCE TO RELATED APPLICATION

The present application claims priority to Korean Patent Application No. 10-2024-0035583, filed on Mar. 14, 2024 in Korea, the entire contents of which is incorporated herein for all purposes by this reference.

### BACKGROUND OF THE PRESENT DISCLOSURE

### Field of the Present Disclosure

The present disclosure relates to a method and apparatus for calibrating an orientation angle of a sensor by use of vehicle weight information while driving.

### Description of Related Art

The content described hereinbelow merely provides background information on the present disclosure and does not constitute the related art.

A sensor (e.g., front camera, front radio detection and ranging (RADAR), etc.) of Advanced Driver Assistance Systems (ADAS) used in a current vehicle is usually changed in angle as a vehicle posture changes due to the loading condition of the vehicle, such as the number of passengers or the loading of a heavy object.

FIG. 1A and FIG. 1B are diagrams illustrating a change in angle of an image sensor such as a front camera or a front radar.

As shown in FIG. 1A and FIG. 1B, assuming that the front orientation angle of an image sensor 110 mounted on a vehicle 100 is 0° when the vehicle 100 is empty, the front orientation angle of the image sensor 110 of the vehicle 100 may change by, for example, 0.7° when the vehicle 100 is loaded with cargo of a certain weight (e.g., 20 tons).

Conventionally, to measure and calibrate a change amount in orientation angle of the ADAS sensor, there has been used a method in which a change amount in sensor orientation angle is recognized and calibrated through driving on the road, internally improving the accuracy of lane and front object recognition.

Conventional driving calibrating technology may not know the change amount in orientation angle of the image sensor 110 before driving on the road. Furthermore, when road environment is poor, it takes about 5 to 40 minutes to calibrate the image sensor 110 while driving on the road, and situations often occur where there is no lane information or calibration may not be performed while driving on the road.

If the calibration of the orientation angle of the image sensor 110 is not completed while driving on the road, sensor detection performance deteriorates, and the performance of the autonomous driving function of the vehicle provided with the sensor 110 also deteriorates. In the worst case, this may cause malfunction or non-operation of the autonomous driving function, resulting in a risk to the safety of passengers.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and apparatus for calibrating an orientation angle of a sensor by use of vehicle weight information while driving.

The problems to be solved by the present disclosure are not limited to the above-mentioned problems, and other problems which are not mentioned will be clearly understood by those skilled in the art from the following description.

According to an aspect of the present disclosure, an apparatus for calibrating an angle of a camera sensor including a memory storing one or more instructions and one or more processors configured to execute the one or more instructions stored in the memory, wherein the one or more processors, by executing the one or more instructions, perform steps including, storing a front-angle change amount information which includes a front-angle change amount of an image sensor mounted on a vehicle according to a total loading weight, a front-axle loading weight, and a rear-axle loading weight by a load of the vehicle; determining a full weight which is actual total loading weight of the front-axle, a first weight which is an actual loading weight of the front axle and a second weight which is an actual loading weight of the rear axle, predicting the front-angle change amount of the image sensor by referring to the front-angle change amount information based on the full weight, the first weight and the second weight and controlling the autonomous driving vehicle by use of the front-angle change amount of the image sensor.

According to another aspect of the present disclosure, a method for calibrating an angle of a camera sensor including, storing a front-angle change amount information which includes a front-angle change amount of an image sensor mounted on a vehicle according to a total loading weight, a front-axle loading weight, and a rear-axle loading weight by a load of the vehicle, determining a full weight which is actual total loading weight of the front-axle, a first weight which is an actual loading weight of the front axle and a second weight which is an actual loading weight of the rear axle, predicting the front-angle change amount of the image sensor by referring to the front-angle change amount information based on the full weight, the first weight and the second weight and controlling the autonomous driving vehicle by use of the front-angle change amount of the image sensor.

According to various exemplary embodiments of the present disclosure, it includes an effect of predicting a change amount in sensor angle with high accuracy by checking the ratio of a vehicle weight and front/rear axle weight, under environment where calibration of a camera sensor angle is not performed yet while driving or it is difficult to calibrate the angle while driving.

As the vehicle drives, more data on angle change compared to weight and front/rear axle ratio may be obtained, allowing a sensor angle change amount to be predicted with high accuracy.

Even before calibrating a camera sensor angle, it includes an effect of enhancing vehicle and driver safety and convenience by preventing performance degradation, malfunction, or non-operation of an autonomous driving function.

Furthermore, it is possible to improve the reliability of an autonomous driving function, leading to positive responses from customers.

Effects that may be obtained by the present disclosure are not limited to the above-mentioned effects, and other effects which are not mentioned will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are diagrams illustrating a change in angle of an image sensor such as a front camera or a front radio detection and ranging (RADAR).

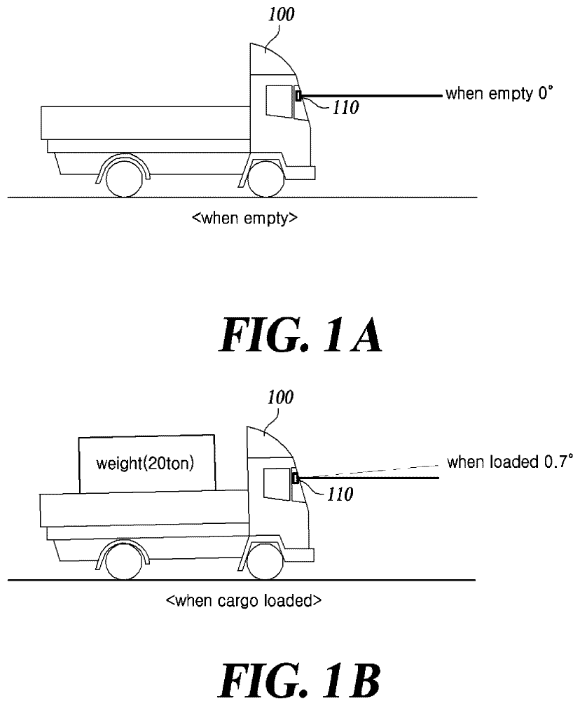

FIG. 2 is a functional block diagram illustrating an apparatus 200 for calibrating an angle of a front camera sensor according to an exemplary embodiment of the present disclosure.

FIG. 3A is a diagram illustrating a change amount in orientation angle of an image sensor when a vehicle is evenly loaded, FIG. 3B is a diagram illustrating a change amount in orientation angle of the image sensor when the vehicle is loaded mainly on the rear side, and FIG. 3C is a diagram illustrating a change amount in orientation angle of the image sensor when the vehicle is loaded mainly on the front side thereof.

FIG. 4 is a graph illustrating a change amount in orientation angle of the image sensor according to the loading weight of the vehicle.

FIG. 5 is a flowchart showing a method of calibrating an orientation angle of a sensor according to an exemplary embodiment of the present disclosure.

FIG. 6 is a block diagram schematically illustrating an example computing device which may be used to implement the methods or devices according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to the accompanying drawings. In the following description, like reference numerals designate like elements, although the elements are shown in different drawings. Furthermore, in the following description of various exemplary embodiments of the present disclosure, a detailed description of known functions and configurations incorporated therein will be omitted for clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which an exemplary embodiment of the present disclosure may be practiced.

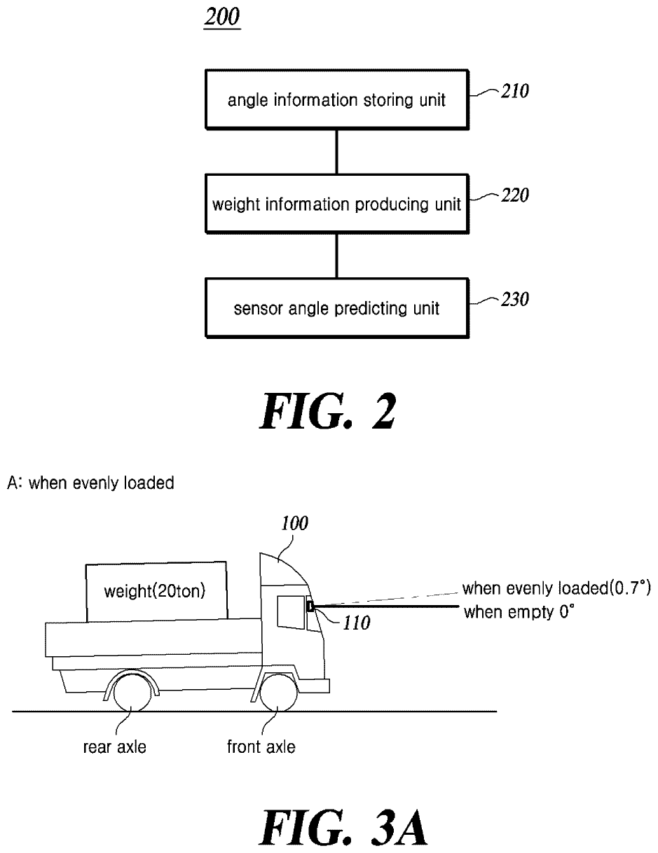

FIG. 2 is a functional block diagram illustrating an apparatus 200 for calibrating an orientation angle of a sensor according to an exemplary embodiment of the present disclosure.

The apparatus 200 for calibrating the orientation angle of the sensor according to an exemplary embodiment of the present disclosure includes an angle information storing unit 210, a weight information producing unit 220, and a sensor angle predicting unit 230. Not all blocks shown in FIG. 2 are essential components. In other exemplary embodiments of the present disclosure, some blocks included in the sensor orientation angle calibrating apparatus 200 may be added, changed or deleted. Meanwhile, components shown in FIG. 2 represent functionally distinct elements, and at least one component may be implemented in an integrated form in an actual physical environment.

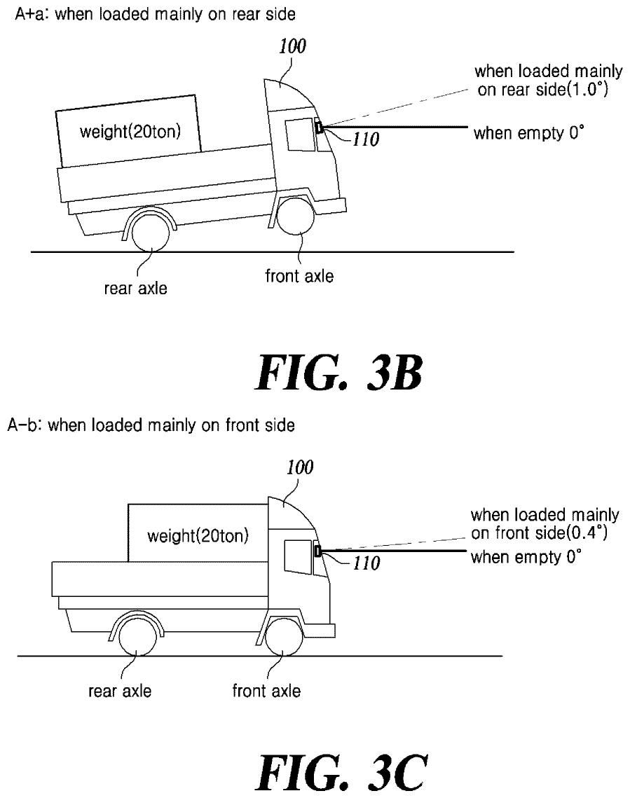

FIG. 3A is a diagram illustrating a change amount in orientation angle of an image sensor when a vehicle is evenly loaded, FIG. 3B is a diagram illustrating a change amount in orientation angle of the image sensor when the vehicle is loaded mainly on the rear side of the vehicle, and FIG. 3C is a diagram illustrating a change amount in orientation angle of the image sensor when the vehicle is loaded mainly on the front side of the vehicle.

As shown in FIG. 3A, FIG. 3B and FIG. 3C, the change amount in orientation angle of the image sensor 110 may vary depending on whether cargo is evenly loaded at front and rear positions within the loading space of the vehicle 100, whether cargo is loaded mainly on the rear side of the vehicle 100, or whether cargo is loaded mainly on the front side of the vehicle 100.

Here, the image sensor 110 refers to a sensor configured for detecting an object, such as a camera sensor, a Light Detection and Ranging (LiDAR) sensor, or radio detection and ranging (RADAR). In the following description, it is to be noted that the expression “sensor” alone without any further explanation refers to an image sensor 110.

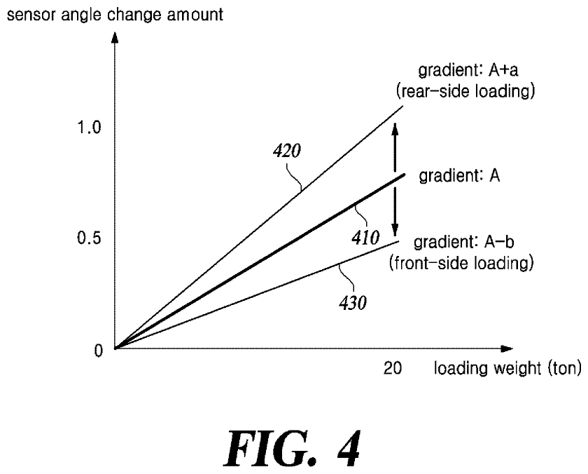

FIG. 4 is a graph illustrating a change amount in orientation angle of the image sensor according to the loading weight of the vehicle.

An angle information storing unit 210 stores a change amount in front orientation angle of the image sensor 110 mounted on the vehicle 100 according to the ratio of the loading weight of a front axle to the loading weight of a rear axle of the vehicle, as front-angle change amount information, in the graph as shown in FIG. 4.

The angle information storing unit 210 stores graphs with different gradients according to the ratio of the loading weight of the front axle to the loading weight of the rear axle as the front-angle change amount information. Here, the front-angle change amount information includes a value which is proportional to a total loading weight for each graph with each gradient.

In this regard, a graph 410 with a gradient A means a change amount in front angle of the sensor according to a total loading weight of the vehicle when the load is oriented in the vehicle such that a ratio of the loading weight of the front axle to the loading weight of the rear axle of the vehicle is equal to 1 (i.e., even loading).

Furthermore, a graph 420 with a gradient A+a indicates rear-oriented loading when the load is oriented in a front direction of the vehicle such that a ratio of the loading weight of the front axle to the loading weight of the rear axle of the vehicle is greater than 1, and a graph 430 with a gradient A−b indicates front-oriented loading when the load is oriented in a rear direction of the vehicle such that a ratio of the loading weight of the front axle to the loading weight of the rear axle of the vehicle is less than 1.

The graph in FIG. 4 may be determined by a predetermined value. In other words, a and b values are values determined as a result of experiment to calibrate the angle of the sensor while driving.

Each of the graph 420 with the gradient A+a and the graph 430 with the gradient A−b may not be provided with only one graph but may be provided with graphs of different gradients according to a ratio value of the loading weight of the front axle to the loading weight of the rear axle of the vehicle.

That is, graphs showing change amounts in orientation angles having different gradients are generated according to the ratio of the loading weight of the front axle to the loading weight of the rear axle of the vehicle.

A graph with any one specific gradient is stored as a graph with a different orientation-angle change amount depending on a total loading weight.

Here, a front-axle loading weight refers to a weight (i.e., load) which is additionally applied to the front axle by a load (people, cargo, etc.) loaded on the vehicle 100. That is, it is a concept that subtracts the weight (i.e., the front axle load when empty) applied to the front axle when empty, from the weight actually applied to the front axle.

A rear-axle loading weight refers to a weight (i.e., load) which is additionally applied to the rear axle by a load of the vehicle 100. That is, it is a concept that subtracts the weight (i.e., the rear axle load when empty) applied to the rear axle when empty, from the weight actually applied to the rear axle.

The total loading weight of the vehicle is the concept of subtracting the weight of the vehicle when empty, from the total weight of the vehicle loaded with cargo.

A weight information producing unit 120 is configured to determine the total actual loading weight (i.e., full weight) of the vehicle 100, the actual loading weight (i.e., first weight) of the front axle, and the actual loading weight (i.e., second weight) of the rear axle.

The weight information producing unit 120 may measure the total weight of the loaded vehicle, the actual applied weight of the front axle, and the actual applied weight of the rear axle from sensors in the vehicle, such as a tire pressure monitoring system (TPMS) mounted on the vehicle, a load sensor mounted on a suspension, or a sensor mounted on a braking system.

The weight information producing unit 120 may obtain the total actual loading weight of the vehicle 100 by subtracting the weight of the vehicle when empty, from the total weight of the vehicle 100 obtained from the sensor in the vehicle.

The weight information producing unit 120 may obtain the actual loading weight (i.e., first weight) of the front axle of the vehicle 100 by subtracting the front axle weight (i.e., load applied to the front axle when empty) when empty, from the actual applied weight of the front axle of the vehicle 100 obtained from the sensor in the vehicle.

The weight information producing unit 120 may obtain the actual loading weight (i.e., second weight) of the rear axle of the vehicle 100 by subtracting the rear axle weight (i.e., load applied to the rear axle when empty) when empty, from the actual applied weight of the rear axle of the vehicle 100 obtained from the sensor in the vehicle. A sensor angle predicting unit 130 predicts the change amount in front angle of the image sensor with reference to the front-angle change amount information of FIG. 4 based on the full weight, the first weight, and the second weight.

The sensor angle predicting unit 130 predicts the change amount in front angle by selecting one graph based on the ratio of the first weight to the second weight among a plurality of graphs stored as the front-angle change amount information. In other words, the sensor angle predicting unit 130 extracts a graph (i.e., first graph) in which the ratio of the front axle loading weight to the rear axle loading weight is the same as the ratio of the first weight to the second weight among the graphs stored by the angle information storing unit 110.

At the present time, the sensor angle predicting unit 130 extracts a value corresponding to the full weight within one selected graph (i.e., first graph), and is configured to determine the extracted value as the change amount in the front angle. That is, the sensor angle predicting unit 130 is configured to determine the actual front orientation angle of the vehicle 100 by adding the amount of change in the front angle to the front orientation angle (i.e., first angle) detected by the image sensor 110.

In an exemplary embodiment of the present disclosure, the angle information storing unit 210, the weight information producing unit 220, and the sensor angle predicting unit 230 may be implemented as separate processors. Alternatively, the angle information storing unit 210, the weight information producing unit 220, and the sensor angle predicting unit 230 may be implemented as a single integrated processor.

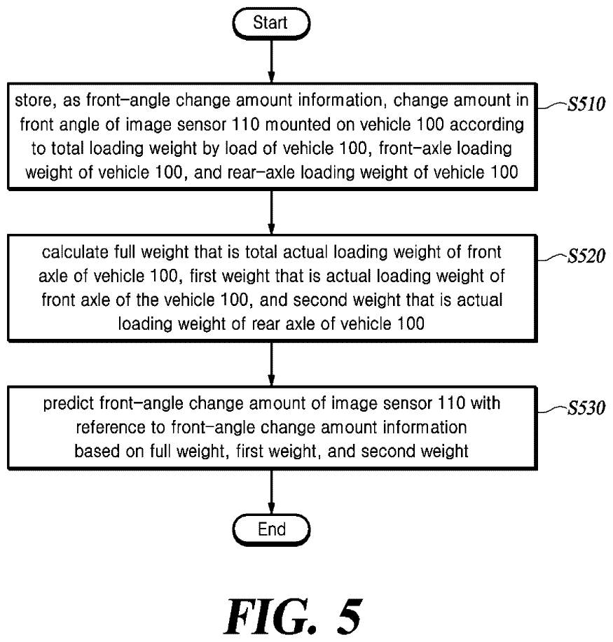

FIG. 5 is a flowchart showing a method of calibrating an orientation angle of a sensor according to an exemplary embodiment of the present disclosure.

The method of calibrating the orientation angle of the sensor according to an exemplary embodiment of the present disclosure is performed by the sensor orientation-angle calibrating apparatus 200.

The angle information storing unit 210 is configured to perform an angle information storage process of storing, as the front-angle change amount information, the change amount in front angle of the image sensor 110 mounted on the vehicle 100 according to the total loading weight by the load of the vehicle 100, the front-axle loading weight of the vehicle 100, and the rear-axle loading weight of the vehicle 100 (S510).

The weight information producing unit 220 is configured to perform the weight-information determination process of determining the full weight which is the total actual loading weight of the front axle of the vehicle 100, the first weight which is the actual loading weight of the front axle of the vehicle 100, and the second weight which is the actual loading weight of the rear axle of the vehicle 100 (S520).

The sensor angle predicting unit 230 is configured to perform the sensor-angle prediction process of predicting the front-angle change amount of the image sensor 110 with reference to the front-angle change amount information based on the full weight, the first weight, and the second weight (S530).

In an exemplary embodiment of the present disclosure, the apparatus 200 for calibrating an angle of a front camera sensor may control the autonomous driving vehicle by use of the front-angle change amount of the image sensor 110.

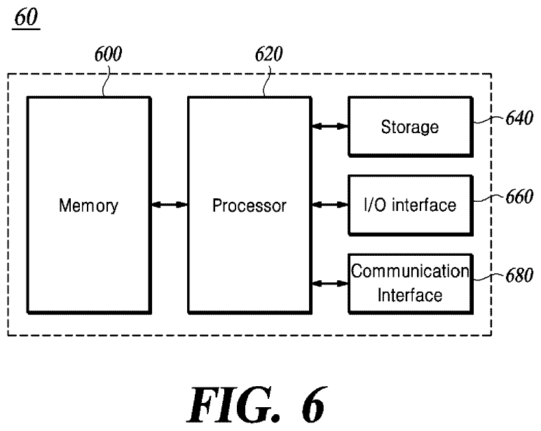

FIG. 6 is a block diagram schematically illustrating an example computing device which may be used to implement the methods or devices according to various exemplary embodiments of the present disclosure.

A computing device 60 may include some or all of a memory 600, a processor 620, a storage 640, an input and output (I/O) interface 660, and a communication interface 680. The computing device 60 may structurally and/or functionally include at least a portion of the angle information storing unit 210, the weight information producing unit 220 or the sensor angle predicting unit 230. The computing device 60 may be a stationary computing device such as a desktop computer, a server, or an AI accelerator, or a mobile computing device such as a laptop computer or a smart phone.

The memory 600 may store a program that allows the processor 620 to perform methods or operations according to various embodiments of the present disclosure. For example, the program may include a plurality of instructions that are executable by the processor 620. The method illustrated in FIG. 5 may thus be performed by the plurality of instructions being executed by the processor 620.

The memory 600 may be a single memory or a plurality of memories. In the instant case, information required to perform methods or operations according to various embodiments of the present disclosure may be stored in the single memory or divided and stored in the plurality of memories. When the memory 600 is configured for the plurality of memories, the plurality of memories may be physically separated.

The memory 600 may include at least one of a volatile memory and a non-volatile memory. The volatile memory includes a static random access memory (SRAM), a dynamic random access memory (DRAM), or the like, and the non-volatile memory includes a flash memory.

The processor 620 may include at least one core configured for executing at least one instruction. The processor 620 may execute instructions stored in the memory 600. The processor 620 may be a single processor or a plurality of processors.

The storage 640 maintains stored data even when power supplied to the computing device 60 is cut off. For example, the storage 640 may include a non-volatile memory or may include a storage medium such as a magnetic tape, optical disc, or magnetic disk.

A program stored in the storage 640 may be loaded into the memory 600 before being executed by the processor 620. The storage 640 may store files generated in a program language, and a program generated from a file by a compiler or the like may be loaded into the memory 600. The storage 640 may store data to be processed by the processor 620 and/or data processed by the processor 620.

The I/O interface 660 may provide an interface with an input device such as a keyboard or mouse, and/or an output device such as a display device or printer. a user can trigger execution of a program in the processor 620 through the input device and/or check a processing result of the processor 620 through the output device.

The communication interface 680 may provide access to an external network. For example, the computing device 60 may communicate with another device (for example, the angle information storing unit 210, the weight information producing unit 220 or the sensor angle predicting unit 230) via the communication interface 680.

Each component of the device or method according to an exemplary embodiment of the present disclosure may be implemented as hardware or software, or may be implemented as a combination of hardware and software. Furthermore, the function of each component may be implemented as software and a microprocessor may be implemented to execute the function of the software corresponding to each component.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for controlling an autonomous driving vehicle, the apparatus comprising:
a memory storing one or more instructions; and
at least one processor operatively connected to the memory and configured to execute the one or more instructions stored in the memory,
wherein the at least one processor, by executing the one or more instructions, perform:
storing a front-angle change amount information which includes a front-angle change amount of an image sensor mounted on a vehicle, according to a total loading weight, a front-axle loading weight, and a rear-axle loading weight by a load of the vehicle;
determining a full weight which is actual total loading weight of the front-axle, a first weight which is an actual loading weight of the front axle and a second weight which is an actual loading weight of the rear axle;
predicting the front-angle change amount of the image sensor by referring to the front-angle change amount information based on the full weight, the first weight and the second weight; and
controlling the autonomous driving vehicle by use of the front-angle change amount of the image sensor.

2. The apparatus of claim 1, wherein the storing of the front-angle change amount information includes:
storing a plurality of graphs with different gradients according to a ratio of the front-axle loading weight to the rear-axle loading weight as the front-angle change amount information.

3. The apparatus of claim 2, wherein the front-angle change amount information includes a value which is proportional to the total loading weight for each graph with gradient.

4. The apparatus of claim 3, wherein the predicting of the front-angle change amount of the image sensor includes:
selecting one graph based on a ratio of the first weight to the second weight among the plurality of graphs stored as the front-angle change amount information.

5. The apparatus of claim 4, wherein the predicting of the front-angle change amount of the image sensor includes:
determining a value corresponding to the full weight in the one graph as the front-angle change amount.

6. A method for controlling an autonomous driving vehicle, the method comprising:
storing a front-angle change amount information which includes a front-angle change amount of an image sensor mounted on a vehicle according to a total loading weight, a front-axle loading weight, and a rear-axle loading weight by a load of the vehicle;
determining, by at least one processor, a full weight which is actual total loading weight of the front-axle, a first weight which is an actual loading weight of the front axle and a second weight which is an actual loading weight of the rear axle;
predicting, by the at least one processor, the front-angle change amount of the image sensor by referring to the front-angle change amount information based on the full weight, the first weight and the second weight; and
controlling, by the at least one processor, the autonomous driving vehicle by use of the front-angle change amount of the image sensor.

7. The method of claim 6, wherein the storing of the front-angle change amount information includes:
storing a plurality of graphs with different gradients according to a ratio of the front-axle loading weight to the rear-axle loading weight as the front-angle change amount information.

8. The method of claim 7, wherein the front-angle change amount information includes a value which is proportional to the total loading weight for each graph with gradient.

9. The method of claim 8, wherein the predicting of the front-angle change amount of the image sensor includes:
selecting one graph based on a ratio of the first weight to the second weight among the plurality of graphs stored as the front-angle change amount information.

10. The method of claim 9, wherein the predicting of the front-angle change amount of the image sensor includes:
determining a value corresponding to the full weight in the one graph as the front-angle change amount.
